(19) United States
(12) Patent Application Publication
(10) Pub. No.: US 2010/0294520 A1
(43) Pub. Date: Nov. 25, 2010

(54) FIRE SHIELD SYSTEM

(76) Inventor: Alfredo Aguirre, Mendoza (AR)

Correspondence Address: DILWORTH & BARRESE, LLP, 1000 WOODBURY ROAD, SUITE 405, WOODBURY, NY, 11797, US

(21) Appl. No.: 12/782,939

(22) Filed: May 19, 2010

Related U.S. Application Data
(60) Provisional application No. 61/216,575, filed on May 19, 2009.

(51) Int. Cl. A62C 3/00

(52) U.S. Cl. 169/45; 169/48

(57) ABSTRACT

A fire shield system includes a fire shield which is extendible in response to an activation signal to shield an object to be protected from an external fire, and deployment means activatable by said signal to deploy said fire shield into an extended configuration.

### CROSS REFERENCE TO RELATED APPLICATIONS

This application claims priority to U.S. provisional application No. 61/216,575 filed May 19, 2009, which is herein incorporated by reference

### BACKGROUND

The present invention relates to a shield system including a fire resistant shield, which can be deployed to protect buildings, machinery, vehicles or forest areas in the event of a fire.

There is clearly a need to protect buildings, especially homes, in areas which may be subject to wildfires. Such wildfires, for example in forested areas, spread rapidly during dry seasons. Burning embers carried by the wind ignite dry foliage at a distance from the actual fire and threaten residences downwind of the fire. The property damage in fire prone areas can be extensive. For example, in 2007 the property damage from wildfires in Southern California exceeded $1 billion.

Various means for shielding an object from an external fire are known. For example, U.S. Pat. No. 6,742,305 to Rogers et al. discloses a fire protection cover apparatus for buildings, especially in the event of a wildfire. The apparatus includes rolls of fire shield material, such as Nomex® brand material which can be unrolled over and down the side of a house or other such building structure. However, Rogers et al. does not disclose the automatic deployment of the fire shield material.

U.S. Pat. No. 6,658,801 to Kilduff et al. is directed to a portable fire curtain system and discloses a cloak of fire shield material for openings in buildings. In contrast to the present invention, the cloak of fire shield material is manually deployed by being carried to an elevated position on a building, such as an upper window, and deployed by means of weights connected to a lower end of the fire curtain. Moreover, the fire curtain does not envelop the building but is intended to cover a window.

U.S. Pat. No. 3,715,843 to Ballinger is directed to a fire protection apparatus for a building and discloses a fire shield material for covering building structures. Unlike the present invention, the Ballinger fire shield apparatus is manually installed and deployed.

While fire shields for buildings are known, there is yet a need for a shield which deploys automatically and rapidly, especially in the event that personnel are not present to manually deploy the shield.

### SUMMARY OF THE INVENTION

A fire shield system is provided herein. The fire shield system of the present invention comprises a fire shield which is extendible in response to an activation signal to shield an object to be protected from an external fire; and deployment means activatable by said signal to deploy said fire shield into an extended configuration.

In one embodiment of the present invention, the fire shield system of the present invention includes a tubular frame that can be Inflatable, filled with a liquid, semi-solid or solid flame retardant material.

In one embodiment of the present invention, the fire shield system comprises a fire resistant aramid fiber fabric.

In one embodiment of the present invention, the fire shield system includes a laminate structure having a metal film disposed on one side of the aramid fiber fabric and a sheet of backing material on an opposite side of the aramid fiber fabric.

In one embodiment of the present invention, the fire shield system includes a mast having an anchoring frame in the vicinity of a top portion thereof, and at least one guy wire having one end attached to the anchoring frame, wherein the tubular frame of the fire shield is attached to the at least one guy wire by links slidably disposed over said guy wire.

In one embodiment of the present invention, the fire shield system method for protecting a combustible object from an external fire, comprising
(a) providing a fire shield system including:
   i. a fire shield which is extendible from an undeployed configuration to a deployed configuration in response to an activation signal to shield the combustible object from the external fire, and
   ii. deployment means activatable by said signal to extend said fire shield into the deployed configuration;
(b) deploying said fire shield between the combustible object and the external fire.

The fire shield system and method of deployment thereof is further described in connection with the figures and detailed description provided below.

### BRIEF DESCRIPTION OF THE DRAWINGS

Various embodiments are described below with reference to the drawings Wherein:

FIG. 1 is a perspective view of a deployed fire shield according to the invention;

FIG. 2 is a diagrammatic view of the deployed fire shield;

FIG. 3 is an illustration of an alternative fire shield fence of the invention;

FIG. 4 is a diagrammatic illustration of a drapable fire shield;

FIGS. 5 and 6 diagrammatically illustrate another fire shield of the invention in, respectively, undeployed and deployed configurations;

FIG. 7 is a sectional view of a fire shield material usable in the present invention.

FIG. 8 is an elevational view of a fire shield system;

FIG. 9 is an elevational view of a mast component of the fire shield system;

FIG. 10 illustrates a fire shield modular unit in a folded configuration;

FIG. 11 illustrates a fire shield modular unit in a deployed configuration;

FIGS. 12 to 14 illustrate a fastener connection between the columns of two adjacent modular units; and

FIG. 15 is a diagrammatic plan view illustrating the deployment of a fire shield system around a building.

### DETAILED DESCRIPTION OF THE PREFERRED EMBODIMENT(S)

The present invention may be understood more readily by reference to the following detailed description of the invention taken in connection with the accompanying drawing figures, which form a part of this disclosure and in which like numbers indicate like features. It is to be understood that this invention is not limited to the specific devices, methods, conditions or parameters described and/or shown herein, and that the terminology used herein is for the purpose of describing particular embodiments by way of example only and is not intended to be limiting of the claimed invention. Also, as used in the specification and including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value.

Similarly, when values are expressed as approximations, by use of the antecedent “about,” it will be understood that the particular value forms another embodiment. It is also understood that all spatial references, such as, for example, horizontal, vertical, top, upper, lower, bottom, left and right, are for illustrative purposes only and can be varied within the scope of the disclosure. For example, the references “upper” and “lower” are relative and used only in the context to the other, and are not necessarily “superior” and “inferior”. As used herein, “comprising”, containing”, “characterized by” and grammatical equivalents thereof are inclusive or open-ended terms that do not exclude additional, unrecited elements or method steps, but will also be understood to include the more restrictive terms “consisting of and “consisting essentially of.”

The following discussion includes a description of an implant system, related components and exemplary methods of employing the implant system in accordance with the principles of the present disclosure. More particularly, the exemplary embodiments of the implant are particularly suitable for use in dental surgery and provide a stable anchoring for a dental prosthesis such as an artificial tooth. Additional embodiments are also disclosed. It should be noted that the implant of the invention can also be used in any type of surgery in which a device is to be attached to bone. Accordingly, the scope of the present invention is not limited to only dental implants. Reference will now be made in detail to the exemplary embodiments of the present disclosure, which are illustrated in the accompanying figures.

The fire shield system of the invention includes a fire shield made of a fire resistant sheet material which can be moved from an unextended configuration (e.g., folded or collapsed) to an extended configuration to shield an object such as a building, a vehicle, a piece of machinery, or any other object which can be damaged by extreme heat. The system also includes means for deploying the fire shield to the extended configuration in response to a signal. The signal can be generated automatically or remotely by radio so as to preclude the need for a person to be on the premises.

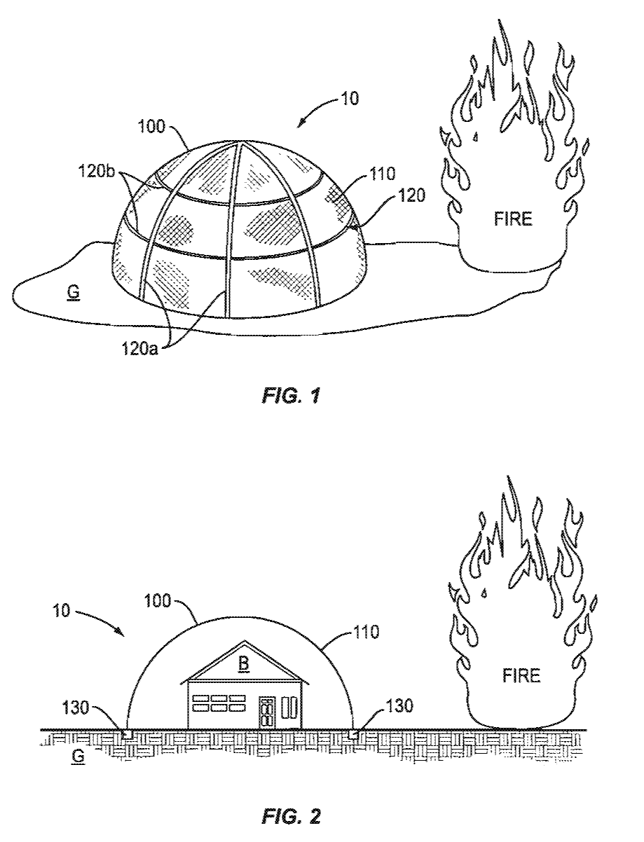

Referring now to FIGS. 1 and 2, the fire shield system 10 is employed to protect building B from the external fire. Fire shield system 10 includes deployment units 130 and an extendible fire shield 100. Deployment units 130 are positioned on the ground G, or buried near the surface of the ground. A plurality of deployment units 130 are positioned around building B at a distance therefrom so as to provide a space between the building B and the fire shield 100 when deployed.

Fire shield 100 includes a fire resistant fabric or sheet 110 and a flexible support frame 120 for supporting fire resistant fabric 110.

The fire resistant fabric 110 can be any fabric which is either noncombustible or self extinguishing. It should be capable of withstanding the high temperatures typically encountered in the vicinity of a fire without substantial degradation. A suitable fire resistant material for use in the invention is fabricated from aramid fiber. In particular, a preferred material is an aromatic nylon, a meta-aramid, which is commercially available in sheet or fiber form under the designation Nomex® from DuPont. The Nomex® material can be attached, for example, by sewing or bonding to the tubular frame 120.

Support frame 120 comprises vertical columns 120a and lateral members 120b. The vertical columns 120a, and optionally the lateral members 120b, are preferably flexible tubular members capable of being inflated. Support frame 120 with fire resistant material 110 is initially contained in the deployment units 130 in a collapsed or folded configuration. Upon activation of the deployment units 130 by a signal, the support frame 120 is inflated with a fluid such as air, water or expandible fire resistant foam. The fire shield 100 then extends into a dome configuration as shown in FIG. 1 to surround building B on all sides in a fire resistant enclosure. In an alternative embodiment tubular frame 120 can comprise telescoping tubular units movably connected to each other in a concentric arrangement, and extendible upon inflation with a fluid.

The signal can be generated automatically by a trigger adapted to inflate the tubular support frame 120 by activating a pump or other means of introducing fluid into the tubular support frame 120 in response to the detection of a predetermined elevated ambient temperature. Alternatively, the trigger can be adapted to respond to smoke, ambient levels of carbon dioxide or carbon monoxide in comparison with normal levels, infrared radiation and/or the spectral characteristics of a fire. In yet another alternative the trigger can be activated remotely by a radio signal.

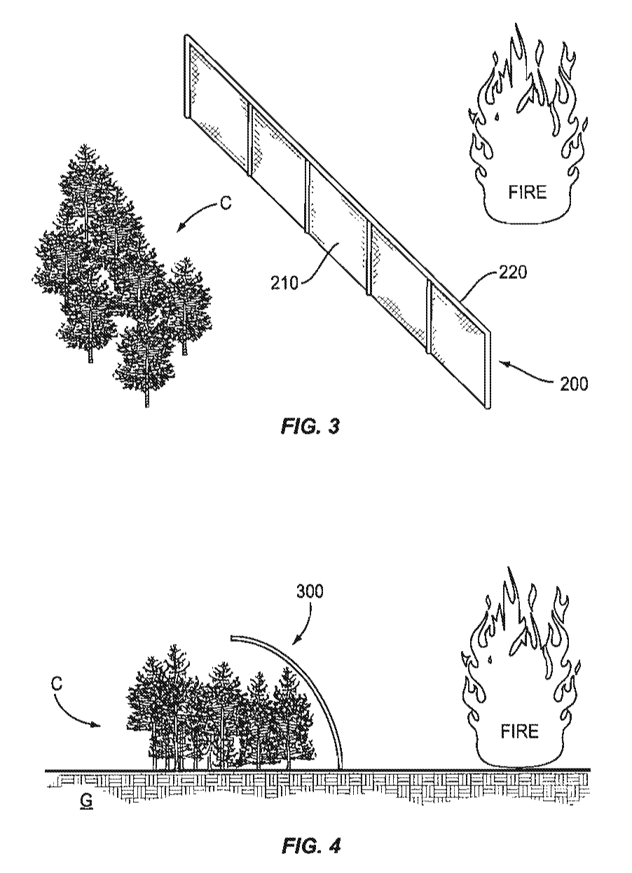

Referring now to FIG. 3 in another embodiment the fire shield system 200 is deployed as a fence, for example, in a forest environment, between a fire and an area C of combustible material, i.e., trees and shrubbery in a dry condition. Fire shield system 200 includes a fire resistant sheet material 210 such as described above, supported by an inflatable tubular support structure 220, optionally with telescoping tubular members. Fire shield system 200 can include deployment units (not shown) for inflating the tubular structure 220, and it can be dropped by aircraft into a fire zone for the protection of fire fighters and to prevent the spread of the fire. The fire prevention fence system is flexible and can be configured to conform to the terrain. It can range from about 5 feet to about 500 feet in height preferably up to 200 feet, more preferably up to 100 feet, when fully deployed. It can be of modular construction so as to provide portions which can be connected on the ground by fire fighters to provide a fence of any desired length and shape.

Referring to FIG. 4, in an alternative embodiment fire shield system 300 is similar to embodiment 200 except that it can be dropped by aircraft over the forest area C and automatically deploys to form a protective canopy to prevent ignition of the tree tops and shrubs from windborne burning embers.

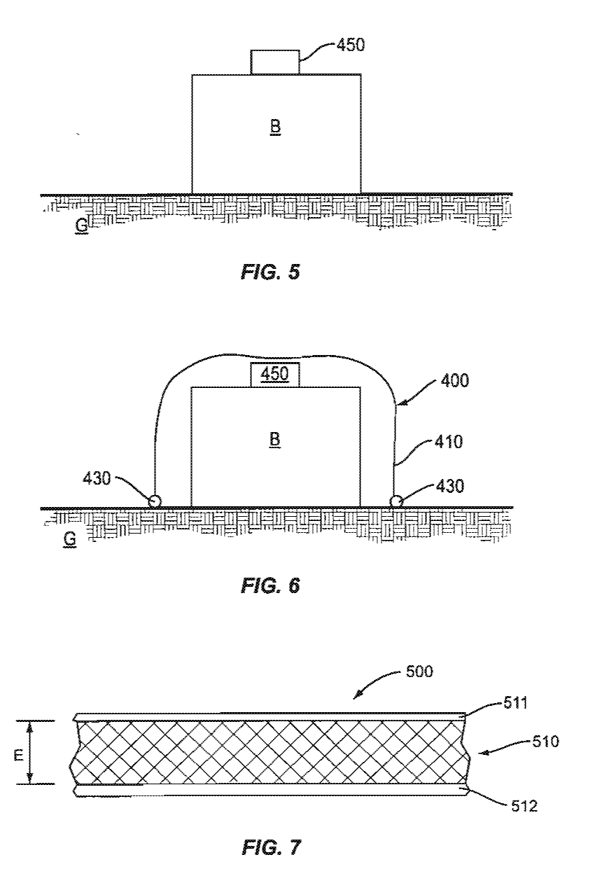

Referring to FIGS. 5 and 6, a fire shield system 400 includes a fire resistant sheet or fabric shield 410 such as the Nomex® material described above, and a deployment unit 450. Weights 430 are connected to, or in the vicinity of, the edge of the fire shield 410. One or more deployment units 450, with the fire shield 410 and weights 430 contained therein, are positioned on top of an object B to be protected from fire such as a building, vehicle, or item of machinery. Upon activation of the deployment unit 450 by an appropriate signal the weights 430 are ejected from the deployment unit 450 and carry the fire shield material 410 over and around the object B to cover it with a fire resistant canopy. Ejection of the weights 430 can be accomplished by, for example, detonation of explosive squibs, release of compressed gas, spring mechanisms or any other suitable means.

Referring now to FIG. 7, in the embodiments described above, the fire shield material can be fabricated in a laminate structure with an expandable form of Nomex® material. For example, fire shield 500 includes expandable Nomex® fabric material 510 sandwiched between a metal film or coating 511 and a backing material 512. The metal film advantageously reflects heat radiation away from the shield. Backing material 512 can be any suitable polymer film or sheet which is flexible and preferably noncombustible or self extinguishing. Such polymers include, for example, polyimides, polyetherimides, polyetherketones, Nomex® sheet, and the like. Expandible Nomex® fabric is a fibrous material wherein the thickness of the fabric expands at a temperature of above about 250 degrees F. to entrap more air for greater insulation. The expansion is illustrated in the direction shown by arrows E.

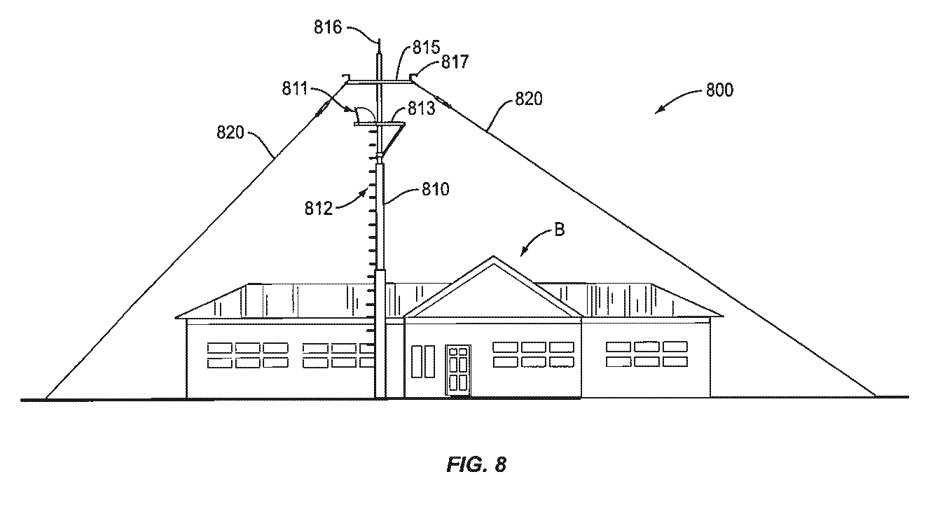

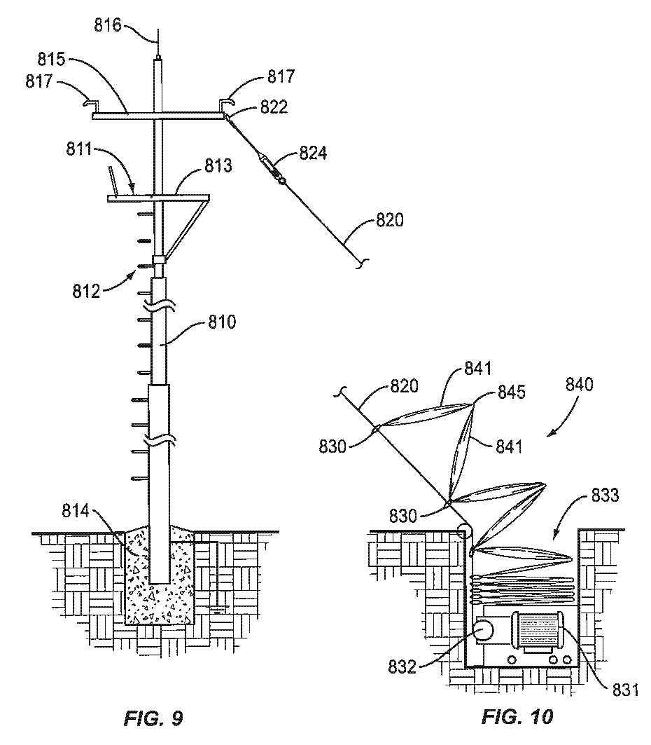

Referring now to FIGS. 8 and 9, a fire shield system 800 is illustrated. A mast 810 is erected in the vicinity of a building B to be protected from fire. The mast can be of any suitable height. Typically, the mast for a single story building can range from about 20 to 50 feet in height depending upon the height of the building and the area to be protected. The mast 810 can be constructed as a telescoping structure. The bottom of mast 810 is firmly encased in a foundation 814 of concrete or cement. A lightning rod 816 is associated with the mast to conduct electric current from a lightning strike away from the building B and safely to the ground. The mast 810 includes a ladder 812, leading up to a platform 813 which a worker can access through hatch 811. A circular anchoring frame 815 is attached at an upper portion of the mast 810. Optionally, a water sprayer 817 can be positioned on the anchoring frame with a nozzle 817 directed towards the deployed fire resistant panel 841 to spray water on the outer surface of the fire resistant panel 841. This arrangement offers additional protection against the radiant heat of a nearby fire.

A plurality of guy wires 820 extend from the ground to the upper portion of the mast 810. Each guy wire 820 includes a harness 822 at Its upper end which can be clipped onto the anchoring frame 815 with a snap-link type connection. Preferably, each guy wire 820 also includes a turnbuckle 824 to apply the appropriate tension to the guy wire 820.

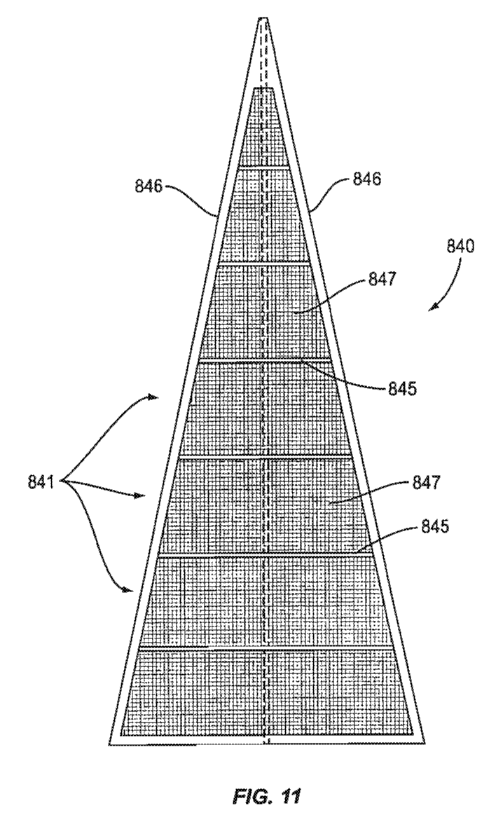

Referring also now to FIGS. 10 and 11, the fire shield modular unit 840 comprises a plurality of fire resistant panels 841 delimited by lateral rods 845 and tubular columns 846. The fire resistant panels 841 each include fire resistant sheets 847 which are connected at fold lines by the lateral rods 845. Fire resistant sheets 847 can be constructed from the Nomex® material described above. Tubular columns 846 provide vertical support for the fire shield modular unit 840 when they are inflated. Links 830 are rings connected to the fire shield assembly and are slidably disposed around guy wires 820.

The fire shield modular unit 840 is initially in a folded configuration and stored in a well 833 in the ground in a stacked arrangement of panels. A motor 831 and winch 832 are operatively associated with the links 830 to raise the fire shield assembly to a deployed configuration around a building or area to be shielded from fire. During deployment the tubular columns 846 are inflated with a suitable gas such as air, nitrogen, carbon dioxide, etc. or fire resistant foam, or water, to further assist in raising the fire shield modular unit 840. Inflation can be performed by an electrically powered compressor or by tanks of compressed gas.

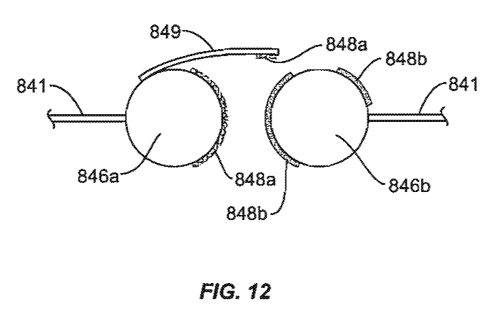

The fire shield modular units 840 can be joined to form fire shield assembly 850 in various configurations to protect buildings and areas from fire damage. Referrin_{g} to FIG. 12, the inflatable tubular column 846 of a first fire shield modular unit 840 is joined to an adjacent inflatable tubular column of a second fire shield modular unit by means of Velcro® hook and loop type fasteners. More particularly, a first tubular column 846a has attached to it a Velcro® fastener 848a and a second Velcro® type fastener 848b is attached to second tubular column 846b. When these tubular columns are brought into juxtaposition the respective Velcro® fasteners adhere to each other thereby joining one fire shield modular unit to the one adjacent to it A flap 849 of fire resistant fabric overlays the joint between the attached tubular columns and is likewise connected to the columns by means of Velcro® fasteners, as shown.

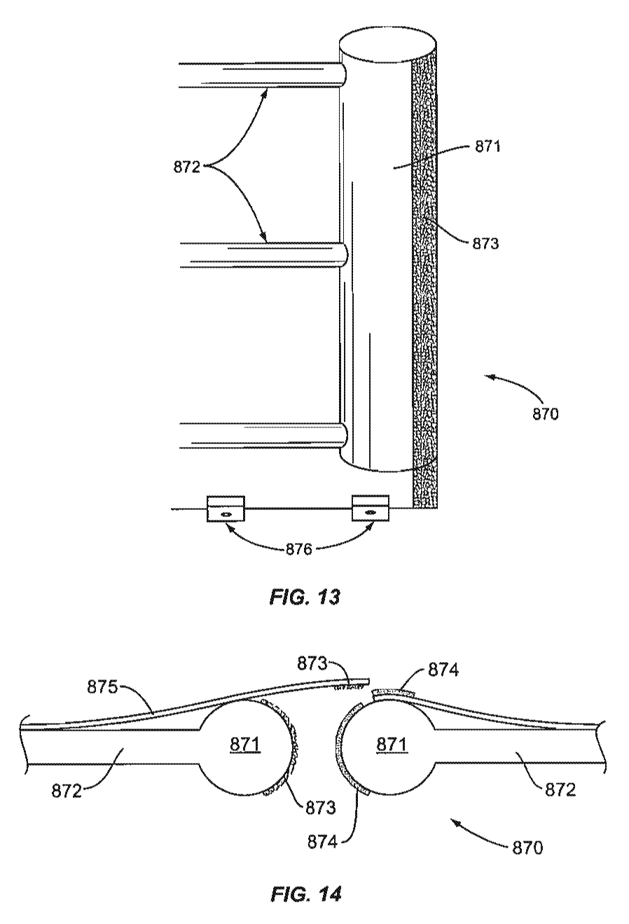

Referring now to FIGS. 13 and 14, the fire shield assembly can comprise one or more Inflatable fire shield modular units 870 connected at their bottom edge(s) by anchoring brackets 876 to the ground, a building or other structure to be protected. Each fire shield modular unit 870 includes an inflatable vertical column 871 on each of two vertical sides of the fire shield modular unit 870 and a plurality of inflatable vertically spaced lateral support tubes 872 extending between the two columns 871 and in fluid communication therewith to form an inflatable fire shield tubular support structure. The columns 871 and support tubes 872 are constructed of flexible material capable of maintaining a gas tight seal. Synthetic polymers suitable for fabricating the fire shield modular unit 870 are known. The columns 871 each include Velcro® type fasteners 873 such that the column 871 of one fire shield modular unit 870 can be attached to an adjacent column of the adjacent fire shield modular unit having corresponding Velcro® type fasteners 874 on contact therewith. The fire shield fabric 875 attached to one fire shield modular unit 870 can also have Velcro® type fasteners 873 for attachment to corresponding Velcro® type fasteners 874 on the adjacent fire shield modular unit 870 so as to overlap the joint between the adjoining fire shield modular units. In an embodiment the fire shield assembly 870 can be erected by inflation of the tubular support structure without the use of a mast system with guy wires as described above.

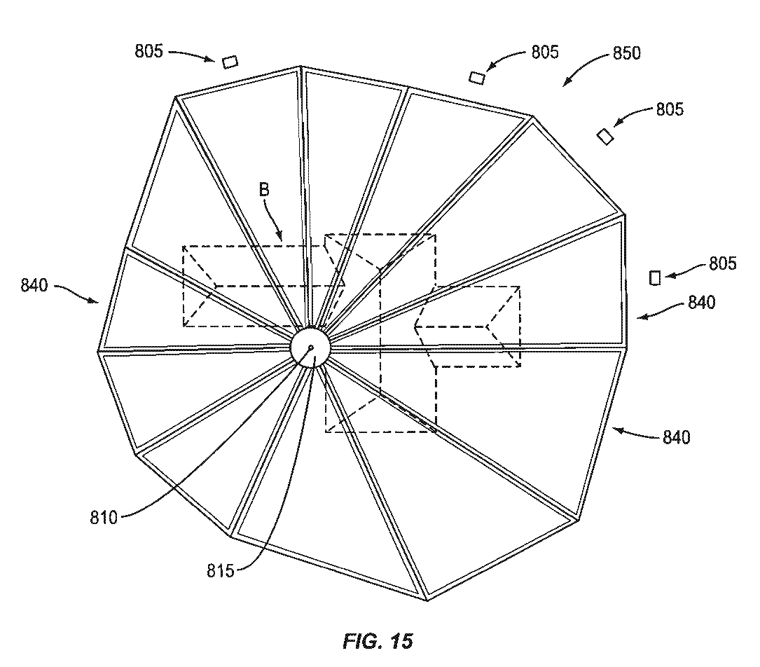

As shown in FIG. 15 fire shield assembly 850 includes a plurality of triangular modular units 840 arranged in a pattern to surround a building B with a fire protecting perimeter. When fully deployed the fire shield assembly envelopes the protected building B and the surrounding area in a dome structure. Alternatively, in another embodiment, a series of masts can be erected in a linear arrangement to provide a fire shield assembly deployed as a fence, for example, to protected a forested areas, as shown in FIG. 3. In such an embodiment the modular units 840 will be quadrangular.

Initially, the fire resistant panels 841 are folded and stacked within respective elongated wells disposed around the periphery of the area to be protected. To deploy the fire shield system 800, the individual guy wires are dipped onto the anchoring frame 815 at the top of the mast. This task can be performed manually by a worker. At the approach of a fire the motor 831 and winch 832 can be actuated to draw up the modular units 840, which are also inflated. Actuation of the motor 831 and winch 832 can be done by manual switching or, preferably, automatically by actuation of one or more suitably located fire sensing units 805. Communication between the fire sensing unit and the fire shield assembly 850 can be by radio transmission upon the detection of a fire outside of the perimeter of the area protected by the fire shield assembly. As mentioned above, the sensing unit can be actuated in response to elevated ambient air temperature, smoke, ambient levels of carbon dioxide or carbon monoxide as compared with normal levels, infrared radiation and/or the spectral characteristics of a flame. A unit power supply provides electrical power to deploy the fire shield assembly. In a typical mode of operation of the fire shield assembly, actuation of a fire detector 805 switches power on to activate an alarm system to notify occupants in the protected area and local fire stations (by audible alarms, cell phone, etc.). Electrical and/or gas service to the premises can optionally be cut off. The fire shield modular units are erected and inflated. And collaborating systems such as pumping water to the sprayer 817 are activated. In the event that a fire shield assembly is positioned on a roof (as shown, for example, in FIGS. 5 and 6) actuation of the fire detector(s) 805 will cause ejection of the fire shield to drape the building.

It should be noted that flash fires such as forest fires burn very hot, but pass over rather quickly because the combustible material, usually the leaves and branches of the upper portions of the trees, is rapidly consumed. A fire shield capable of withstanding high temperatures for the duration can reduce property damage and save firefighters and other persons caught in a fire zone from injury or death.

While the above description contains many specifics, these specifics should not be construed as limitations of the invention, but merely as exemplifications of preferred embodiments thereof. Those skilled in the art will envision many other embodiments within the scope and spirit of the invention as defined by the claims appended hereto.

What is claimed is:

1. A fire shield system comprising:
(a) a fire shield which is extendible from an undeployed configuration to a deployed configuration in response to an activation signal to shield an object to be protected from an external fire; and
(b) deployment means activatable by said signal to extend said fire shield into the deployed configuration.

2. The fire shield system of claim 1 wherein the fire shield includes a tubular frame.

3. The fire shield system of claim 2 wherein the frame is inflatable with a fluid.

4. The fire shield system of claim 3 wherein the deployment means Includes means to inflate said tubular frame with air, water or fire resistant foam.

5. The fire shield system of claim 1 wherein the fire shield comprises a fire resistant aramid fiber fabric.

6. The fire shield system of claim 5 wherein the fire shield has a laminate structure including a metal film disposed on one side of the aramid fiber fabric and a sheet of backing material on an opposite side of the aramid fiber fabric.

7. The fire shield system of claim 6 wherein the aramid fiber fabric sheet is expandable in thickness in response to a predetermined elevated temperature.

8. The fire shield system of claim 1 wherein the signal is radio generated.

9. The fire shield system of claim 1 wherein the signal is automatically generated in response to detection of a predetermined elevated ambient temperature.

10. The fire shield system of claim 1 wherein the deployment means includes one or more explosive squibs.

11. The fire shield system of claim 2 wherein the tubular frame is a telescoping frame.

12. The fire shield system of claim 2 further including a mast having an anchoring frame in the vicinity of a top portion thereof, and at least one guy wire having one end attached to the anchoring frame, wherein the tubular frame of the fire shield is attached to the at least one guy wire by links slidably disposed over said guy wire.

13. The fire shield system of claim 1 wherein the fire shield, in the undeployed configuration, is arranged in a folded stacked configuration of fire resistant panels.

14. The fire shield system of claim 13 wherein the fire resistant panels are delimited by the tubular frame and by lateral rods along which the fire resistant panels are foldably connected.

15. A method for protecting a combustible object from an external fire, comprising:
(a) providing a fire shield system including:
i. a fire shield which is extendible from an undeployed configuration to a deployed configuration in response to an activation signal to shield the combustible object from the external fire, and
ii. deployment means activatable by said signal to extend said fire shield into the deployed configuration;
(b) deploying said fire shield between the combustible object and the external fire.

16. The method of claim 15 wherein the combustible object is a building and the fire shield is configured and dimensioned as a dome capable of surrounding the building on all exposed sides.

17. The method of claim 15 wherein the combustible object is a forest area and the fire shield is configured and dimensional as a fence conformable to features of the terrain.

18. The method of claim 15 wherein the deploying step (b) includes transmitting a radio signal to the deployment means.

19. The method of claim 15 wherein the fire shield includes an inflatable frame and the step of deploying the fire shield includes inflating said frame with air, water or fire resistant foam.

20. The method of claim 15 wherein the signal is automatically generated by the detection of a predetermined elevated ambient temperature.
